(19) United States
(12) Patent Application Publication
(10) Pub. No.: US 2020/0369008 A1
(43) Pub. Date: Nov. 26, 2020

(54) MULTIPLE-LAYER COMPOSITE BOARD OF DISCRETE MATERIALS AND PLASTIC, AND PRODUCTION METHOD THEREOF

(71) Applicant: Minh Tam DO, Ho Chi Minh (VN)

(72) Inventor: Minh Tam DO, Ho Chi Minh (VN)

(21) Appl. No.: 16/877,668

(22) Filed: May 19, 2020

(30) Foreign Application Priority Data
May 21, 2019 (VN) 1-2019-02614

(51) Int. Cl. B32B 21/02; B32B 27/18; B32B 27/08; B32B 38/00; B29C 48/00

(52) U.S. Cl. CPC B32B 21/02; B32B 27/18; B32B 2260/04; B32B 38/004; B29C 48/0011; B32B 27/08

(57) ABSTRACT

The invention relates to a multiple-layer composite board of discrete materials and plastic. The multiple-layer composite board of discrete materials and plastic is formed by providing independently stratified plastic layers and discrete material layers, which are pressed in melting state of the alternate plastic layers and discrete material layers and cooled. Due to this stratification, centralized plastic layers constitute high load capacity and discrete material layers pressed with pressure lower than normal extrusion process constitute low density for the multiple-layer composite board of discrete materials and plastic.

### TECHNICAL FIELD

The present invention relates to multiple-layer composite board of discrete materials and plastic, such as wood-plastic composite (WPC) and production method thereof.

### BACKGROUND ART

The known WPC comprises a compatible proportion of wood and thermoplastic (such as polypropylen, polyethylen or PVC, etc.). Both components of wood and plastic can be resulted from recycled resources. WPC can be manufactured in multiple ways. Currently, the most common technique is extrusion, wherein components of wood (granulated to fine grains), thermoplastic and additives are blended into a mixture that can be in melting state under high temperature and pressure, and can be formed in an extrusion die. WPC is good at waterproofing and sparing with warping or cracking. Additionally, they are durable thanks to their immunity from termites, woodworms and other natural factors. The most crucial shortcoming of WPC is low loadcapacity because of their equal allocation in material of wood and plastic. Another shortcoming of WPC is high density due to the wood being pressed under high temperature and pressure in the extrusion process using plastic such as polypropylene or polyethylene because they are difficult in generating foam as PVC.

### SUMMARY OF INVENTION

The object of the invention is to overcome the drawbacks of the prior art described above; more specifically, to create multiple-layer composite board of discrete materials and plastic with high load-capacity and low density, improved integration between discrete materials and plastic.

In order to serve the aforementioned purposes and others, the present invention proposes a multiple-layer WPC board. Unlike normal WPC wherein the wood (granulated to fine grains), thermoplastic and additives are blended into a mixture in melting state before being formed in an extrusion die, the multiple-layer WPC board of discrete materials and plastic is created from independently stratified plastic layers and discrete material layers, pressed in the melting state of alternate layers of plastic and discrete materials, and cooled. In the pressing process, layers of discrete materials blending with melting plastic from adjacent plastic layers forms plastic-discrete material layers with high proportion of discrete materials. These plastic-discrete material layers integrate with adjacent plastic layers to form the composite board. Due to this stratification, centralized plastic layers constitute high loadcapacity and discrete material layers pressed with pressure lower than normal extrusion process constitute low density for the multiple-layer composite board of discrete materials and plastic.

### BRIEF DESCRIPTION OF DRAWINGS

The present invention will now be described based on accompanying drawings. For the purpose of illustrating the invention, there is shown in the drawings several forms, which are presently preferred, it being understood, however, that the invention is not limited to the precise arrangements and instrumentalities shown, in which:

FIG. 1A illustrates an example multiple-layer composite board of discrete materials and plastic in accordance with an embodiment, wherein this board comprises two plastic layers and one discrete material layer;

FIG. 1B illustrates the area A zoomed in on FIG. 1A;

FIG. 2 illustrates an example multiple-layer composite board of discrete materials and plastic in accordance with an embodiment; wherein this board comprises three plastic layers and two discrete material layers;

FIG. 3 illustrates a method of production of multiple-layer composite board of discrete materials and plastic in accordance with an embodiment;

FIG. 4 illustrates another method of production of example multiple-layer composite board of discrete materials and plastic;

FIG. 5 illustrates a method of production of multiple-layer composite board of discrete materials and plastic in accordance with an embodiment;

FIG. 6 illustrates a method of trial production of multiple-layer composite board of discrete materials and plastic.

### DESCRIPTION OF EMBODIMENTS

The present invention will now be described based on preferred embodiments with reference to the accompanying drawings. In the drawings, like reference characters generally refer to the same parts throughout the different views.

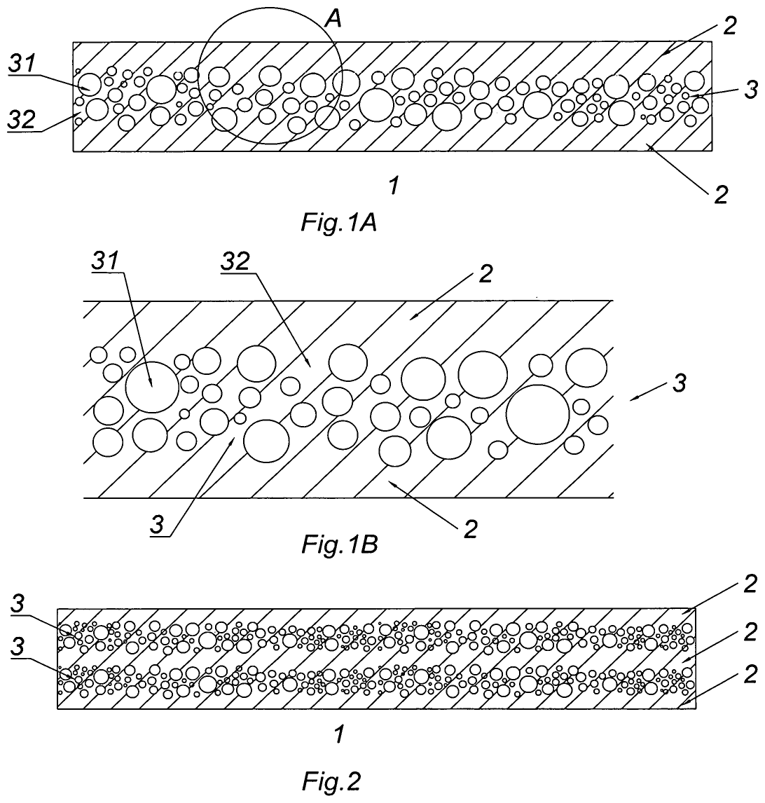

As illustrated in FIG. 1A, the multiple-layer composite board of discrete materials and plastic 1 according to the present invention comprises two plastic layers 2 and one discrete material layer 3 lying in the middle of the two plastic layers 2, wherein the discrete material layer comprises discrete materials 31 mixed with plastic 32.

As illustrated in FIG. 1B, the plastic 32 which is resulted from two plastic layers initially provided flows in to integrate with discrete materials and, in accordance with an embodiment, can integrate with each other. Although the plastic 32 is resulted from two plastic layers 2, the middle layer is called plastic-discrete material layer instead of discrete material layer to emphasize the fact that this layer comprises discrete materials 31 mixed and solidly integrated with plastic layers 2, thanks to which flows into interstices and becomes a part of the plastic-discrete material layer 3.

According to another embodiment illustrated in FIG. 2, the multiple-layer composite board of discrete materials and plastic 1 comprises three plastic layers 2 and two plastic-discrete material layers 3 lying alternately among three plastic layers 2. It means that the present invention is not limited to the number of plastic layers illustrated in FIG. 1A and FIG. 2, therein the multiple-layer composite board of discrete materials and plastic 1 comprises at least two plastic layers 2 and at least one plastic-discrete material layer 3, wherein each plastic-discrete material layer is placed alternately between two plastic layers.

The composite board 1 is formed by providing independently stratified initial plastic layers and discrete material layers, which are pressed in the melting state of the provided plastic layers and discrete material layers placed alternately along the interface of the plastic layers, and cooled. In this pressing process, discrete material layers blending with melting plastic from adjacent plastic layers forms plastic-discrete material layers with high proportion of discrete materials. These plastic-discrete material layers integrate with adjacent plastic layers to form the composite board. Due to the stratification, centralized plastic layers constitute high load capacity for the composite board according to the present invention, centralized discrete material layers being pressed with pressure lower than normal WPC extrusion process constitutes low density for the multiple-layer composite board according to the present invention.

The term “discrete materials” in this specification implies the material under the forms of board or piece, wherein there will be interstices when they are bedded. According to the present invention, the discrete materials, used to form interstices which are large enough for the plastic to flow in, are not integrated on the surface or deeper but deeply integrated as a part of the formed layer, thanks to which forming a composite board 1 comprising solidly integrated layers with not-too-high density.

According to various embodiments, discrete materials can be different. The discrete materials 31 can be granules or planks of wood, splinters, vegetal fibers, glass fibers, fabric fibers, husks, rags or the like. Additionally, a plastic-discrete material layer can comprise two or more types of discrete materials. For composite board 1 comprising multiple plastic-discrete material layers, e.g. two layers as illustrated in FIG. 2, each layer can even comprise various discrete materials.

Discrete materials can have various sizes depending on the material sources.

According to a preferred embodiment of the present invention, discrete materials 31 are granules of wood with the size of 0.5-15 mm.

According to another preferred embodiment, discrete materials 31 are granules prefabricated by granulating extrusion technology, wherein discrete materials such as granules or planks of wood, splinters, vegetal fibers, glass fibers, fabric fibers, husks, rags or the like are ground to granules with size of 0.5-15 mm,thermoplastic and additives are blended to mixture in melting state before forming string shape with size of 1-5 mm in a extrusion die, then cooled and cut into granules with size of 1-15 mm.

Composition of the plastic layers are multifarious, which can be any of the plastic types such as PP, PE, PS, ABS, PA, PET, PVC, etc.

According to another aspect, the present invention proposes the production method of the multiple-layer composite board of discrete materials and plastic. The production method of the multiple-layer composite board of discrete materials and plastic is as follows:

Step 1: there is provided at lease two plastic layers;

Step 2: spread at least one layer of discrete material alternately and along surfaces of the plastic layers;

Step 3: press plastic layers into melting state with discrete materials and cool them down so that two plastic layers adjacent to the discrete material layer are integrated with the discrete materials.

Plastic layers may have been in melting state before the spread of discrete material layer or plastic layers can be in cooling state when spreading the discrete material layer.

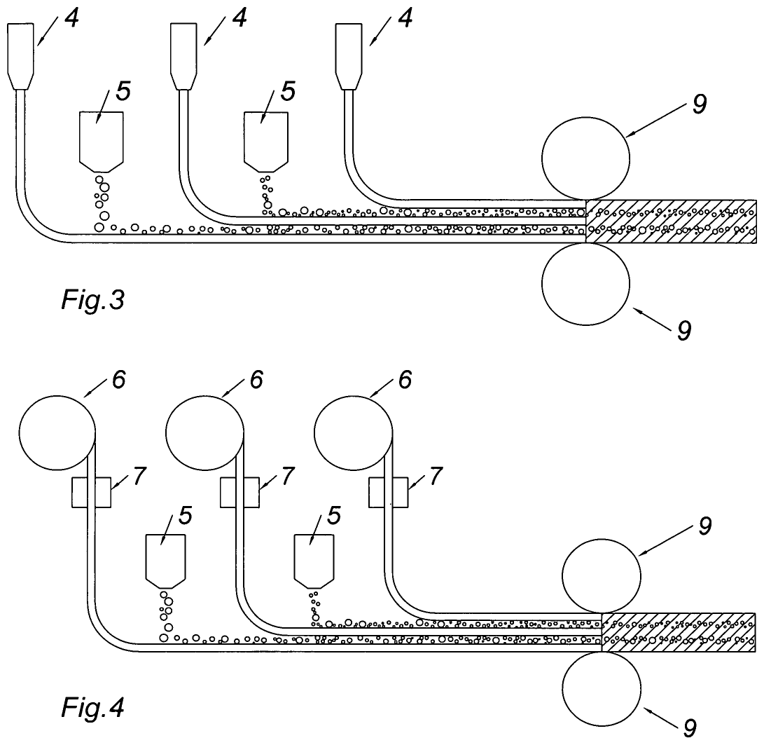

Referring to FIG. 3, plastic layers are extruded directly from extruder in melting state through extrusion dies 4 and discrete materials are spread through spreaders 5. Each spreader 5 is alternately placed among extrusion dies 4 to spread the discrete material layer alternately among plastic layers.

Referring to FIG. 4, plastic layers are provided from available plastic sheets 6 and heated by the heater 7 and discrete materials are spread through spreaders 5. Each spreader 5 is alternately placed among plastic pellicles to spread the discrete material layer alternately among plastic layers.

Referring to FIG. 3 and FIG. 4, these alternate discrete material layers and melting plastic layers are pressed and cooled by roller calender 9 to form the composite board.

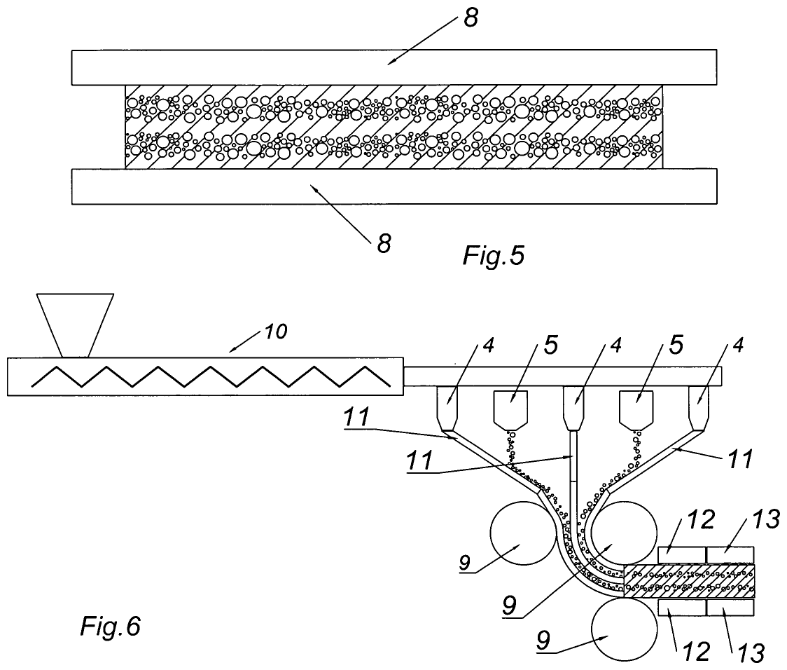

According to another preferred embodiment, as illustrated in FIG. 5, plastic layers are in cooling state when spreading the discrete material layer. Plastic layers are then indirectly melted through clamps 8. Plastic layers are alternately arranged among discrete material layers, then pressed among heating plates and cooled to form WPC board. Plastic layers can also be directly melted by such heat sources as infrared, high frequency induction heating, high pressure steam . . . or the like.

The roller calender for pressing and cooling in the production process of the composite board can be replaced with equivalent structures.

### EXAMPLE

Referring to FIG. 6, the trial production of the composite board uses twin screw extruder with diameter of 65 mm, length of 3000 mm, capacity of 300 kg/h. Plastic material is PE. Discrete materials are wood ground to granules with size of 3-5 mm. PE is melted to 170° C. in barrel of the extruder 10, extruded from three dies 4 to form three plastic layers with width of 1200 mm, thickness of 2 mm in melting state. These three melted plastic layers stream through three extrusion channels 11 to forming roller calender 9. Three extrusion channels are heated to 160° C. for keep melt state of plastic layers. Two layers of wood granules are spread by spreaders 5 alternately among three plastic layers in melting state in front of the forming roller calenders 9 to form a composite board with width of 1200 mm, thickness of 15 mm. This composite board is moved to smoothing structure wherein outside surface of the composite board is plasticized at the temperature of 170° C. by heating plates 12, then cooled and smoothed by cooled plates 13. After size cutting, output of the trial production is a WPC board with size of 2440 mm×1220 mm×15 mm, matching criteria to be used as formwork panels in construction.

While the invention has been shown and described with respect to the preferred embodiments, it will be understood by those skilled in the art that various changes and modifications may be made without departing from the spirit and scope of the invention as defined in the following claims.

### REFERENCE SIGNS LIST

1 Composite board

2 Plastic layer

3 Discrete material layer

31 Discrete materials

32 Plastic

4 Extrusion die

5 Spreader

6 Plastic sheet

7 Heater

8 Clamp

9 Roller calender

A Zoomed area

10 Extruder

11 Extrusion channel

12 Heating plate

13 Cooled plate

I claim:

1. A multiple-layer composite board of discrete materials and plastic comprising at least two plastic layers and at least one plastic-discrete material layer, wherein:
each plastic-discrete material layer is alternately placed in the middle of the two plastic layers;
the plastic-discrete material layer comprises discrete materials mixed with plastic, which is created by pressing plastic layers in melting state with discrete materials spread along the surface of plastic layers, and cooled so that two plastic layers adjacent to the plastic-discrete material layer are integrated with discrete materials.

2. The composite board according to claim 1, wherein said discrete materials comprising at least one material selected from the groups of granules or planks of wood, splinters, vegetal fibers, glass fibers, fabric fibers, husks, rags or the like.

3. The composite board according to claim 2, wherein said discrete materials are planks of wood.

4. The composite board according to claim 1, wherein said discrete materials are granules prefabricated by granulating extrusion technology, wherein discrete materials such as granules or planks of wood, splinters, vegetal fibers, glass fibers, fabric fibers, husks, rags or the like are ground to granules with size of 0.5-5 mm, thermoplastic and additives are blended to mixture in melting state before forming string shape with size of 1-5 mm in aextrusion die, then cooled and cut into granules with size of 1-15 mm.

5. A production method of the multiple-layer composite board of discrete materials and plastic comprising:
step 1: providing at lease two plastic layers;
step 2: spreading at least one layer of discrete material alternately and along surfaces of the plastic layers;
step 3: pressing plastic layers into melting state with discrete materials and cool them down so that two plastic layers adjacent to the discrete material layer are integrated with the discrete materials.

6. The production method according to claim 5, wherein plastic layers are in melting state before spreading the discrete material layer.

7. The production method according to claim 6, wherein plastic layers are extruded directly from extruder and pressed by roller calender or equivalent clamps.

8. The production method according to claim 6, wherein plastic layers are provided from available plastic sheets and heated by the heaters, then pressed by roller calender or equivalent clamps.

9. The production method according to claim 5, wherein plastic layers are in cooling state when spreading the discrete material layer.

10. The production method according to claim 9, wherein plastic layers are melted indirectly through clamps and pressed by clamps.

11. The production method according to claim 9, wherein plastic layers are melted directly by such heat sources as infrared, high frequency induction heating, high pressure steam or the like.
